(19) United States
(12) Patent Application Publication
(10) Pub. No.: US 2025/0168755 A1
(43) Pub. Date: May 22, 2025

(54) PROVISIONING IN-NETWORK COMPUTING SERVICES IN CELLULAR CORE NETWORKS

(71) Applicant: HUAWEI TECHNOLOGIES CO., LTD., Shenzhen (CN)

(72) Inventors: Xun XIAO, Munich (DE); Qing WEI, Munich (DE)

(73) Assignee: HUAWEI TECHNOLOGIES CO., LTD., Shenzhen (CN)

(21) Appl. No.: 19/028,898

(22) Filed: Jan. 17, 2025

Related U.S. Application Data
(63) Continuation of application No. PCT/EP2022/072215, filed on Aug. 8, 2022.

(51) Int. Cl. H04W 48/16; H04L 61/4511; H04W 60/04

(52) U.S. Cl. CPC H04W 48/16; H04L 61/4511; H04W 60/04

(57) ABSTRACT

Disclosed are a user equipment, UE (1), for a cellular network, a plurality of control plane network functions (2-4) of the cellular network, and corresponding methods (5-8) of operating the same. The UE (1) is configured to discover (12) an edge application service, EAS, of the cellular network, wherein the EAS comprises an in-network computing service being based on a network function entity, cNF (4), in a core network of the cellular network. The UE (1) is further configured to establish (13) a protocol data unit, PDU, session being based on the discovered EAS. This enables application service providers (ASP) to deploy in-network application logic (IN-AL) in the 3GPP core network domain for their own application services.

### CROSS-REFERENCE TO RELATED APPLICATIONS

This application is a continuation of International Application No. PCT/EP2022/072215, filed on Aug. 8, 2022, the disclosure of which is hereby incorporated by reference in its entirety.

### TECHNICAL FIELD

The present disclosure relates to the field of communications technology, and more particularly to the provisioning of in-network computing (INC) within core network domains of cellular networks.

### BACKGROUND ART

Traditionally, network devices of cellular networks are vendor-specific. Functionalities such as supported network protocols of conventional network devices are pre-installed, and difficult to be upgraded after being deployed, because hardware chipsets onboard are statically designed and encapsulated in terms of pre-defined specifications.

Such a restriction is being mitigated with the rapid development of programmability technology. Nowadays, programmable network processing unit (NPU) is widely available and the performance of programmable network devices is similar to traditional network devices. The network device may be programmed for packet processing in accordance with an application logic by writing a script in the popular P4 language, for example, which will subsequently be complied, deployed and executed on the programmable chips. This opens an opportunity of customizing a network infrastructure.

The capability of programmability of the network infrastructure inspires the concept of in-network computing (INC). The INC concept means to directly deploy a non-standardized application-specific computing logic onto the networking elements of a forwarding path of a 3GPP core network. With the intermediate computing logic, processing tasks can start much earlier before arriving at the endpoint where the actual application server is located.

According to 3GPP's definition, computational tasks at the application layer (in contrast to the network layer) are considered application services to be provided in a data network (DN), outside the 3GPP network domain. Further, European Telecommunications Standards Institute (ETSI) defined a network architecture named “Multi-access edge computing (MEC)” to enable cloud/edge computing capabilities at the edge of cellular networks.

That is to say, the 3GPP network only provides the connectivity from a user equipment (UE) to a DN or MEC system. If an application service provider (ASP) wants to deploy an in-network application logic (IN-AL) in the 3GPP core network domain for its own application, this is not supported by the current mobile network system (e.g., 5G), specifically, not supported by the control plane (CP) operations.

### SUMMARY

It is an objective to overcome these and other drawbacks. This objective is achieved by the subject-matter of the independent claims. Further implementation forms are apparent from the dependent claims, the description, and the figures.

According to a first aspect, a user equipment, UE, for a cellular network is provided. The UE is configured to discover an edge application service, EAS, of the cellular network, wherein the EAS comprises an in-network computing, INC, service being based on a network function entity, cNF, in a core network of the cellular network. The UE is further configured to establish a protocol data unit, PDU, session being based on the discovered EAS.

This enables a UE to discover and request provisioning an INC service in the core network, wherein the INC service off-loads an existing EAS hosted outside of the cellular network in a data network (DN) domain by preprocessing and/or terminating user plane traffics.

An edge application service (EAS) as used herein may refer to a computing service being associated with an edge application server being hosted in a DN domain. Edge computing enables operator and 3rd party services to be hosted close to the UE's access point of attachment, so as to achieve an efficient service delivery because of the reduced end-to-end latency and load on the transport network.

INC as used herein may refer to a direct deployment of non-standardized application-specific computing logic onto the networking elements of a forwarding path of a 3GPP core network.

A network function entity or computing network function (cNF) as used herein may particularly refer to a user plane function of a 3GPP core network implementing non-standardized application-specific computing logic, which may also be called in-network application logic (IN-AL) because it is deployed within the 3GPP core network.

In a possible implementation form, for discovering the EAS, the UE may further be configured to send a discovery request to an edge application service discovery function, EASDF, of the cellular network. The discovery request may comprise: an identifier of the EAS; a Domain Name Service, DNS, name of the EAS; a query indicator regarding a support of the EAS by the in-network computing service; an identifier of a required version of the in-network computing service; and a query indicator regarding a configuration of the cNF to terminate the EAS.

In a possible implementation form, for discovering the EAS, the UE may further be configured to receive a discovery response from the EASDF. The discovery response may comprise: the identifier of the EAS; the locator address of the EAS comprising the in-network computing service and/or a locator address of a corresponding EAS not comprising the in-network computing service; a response indicator regarding the support of the EAS by the in-network computing service; an identifier of a version of the in-network computing service; and a response indicator regarding the configuration of the cNF to terminate the EAS.

In a possible implementation form, for establishing the PDU session, the UE may further be configured to send a PDU session request to a Session Management Function, SMF, of the cellular network. The PDU session request may comprise the locator address of the EAS comprising the in-network computing service.

In a possible implementation form, for establishing the PDU session, the UE may further be configured to receive a PDU session request acceptance from the SMF. The PDU session request acceptance comprising a locator address for the UE to access the EAS comprising the in-network computing service.

According to a second aspect, a session management function, SMF, for a cellular network is provided. The SMF is configured to establish a PDU session being based on an edge application service, EAS, of the cellular network. The EAS comprises an in-network computing service being based on a registered network function entity, cNF.

This enables a SMF to provision a PDU session that includes an INC service in the core network, wherein the INC service off-loads an existing EAS hosted outside of the cellular network in a DN domain by preprocessing and/or terminating user plane traffics.

In a possible implementation form, for establishing the PDU session, the SMF may be configured to receive a PDU session request from a User Equipment, UE, of the cellular network. The PDU session request may comprise a locator address of the EAS comprising the in-network computing service.

In a possible implementation form, for establishing the PDU session, the SMF may further be configured to select the cNF among a number of registered cNFs of the cellular network; send a configuration request to the selected cNF; and receive a configuration response from the selected cNF. The configuration request may comprise one or more of an entry point of a subsequent cNF of the selected cNF in the EAS; and a termination rule for the EAS. The configuration response may comprise a locator address for the UE to access the EAS comprising the in-network computing service.

In a possible implementation form, for establishing the PDU session, the SMF may further be configured to send a PDU session request acceptance to the UE. The PDU session request acceptance may comprise the locator address for the UE to access the EAS comprising the in-network computing service.

According to a third aspect, an edge application service discovery function, EASDF, for a cellular network is provided. The EASDF is configured to register a network function entity, cNF, for a core network of the cellular network. The EASDF is further configured to inform on an edge application service, EAS, of the cellular network. The EAS comprises an in-network computing service being based on the network function entity, cNF.

This enables an EASDF to register and provide information on an INC service in the core network, wherein the INC service off-loads an existing EAS hosted outside of the cellular network in a DN domain by preprocessing and/or terminating user plane traffics.

In a possible implementation form, for registering the cNF, the EASDF may further be configured to receive a registration request from the cNF; process the profile of the cNF in accordance with the registration request; and send a registration response to the cNF. The registration request may comprise one of: an indicator to create a profile of the cNF at the registration entity, an indicator to update the profile of the cNF at the registration entity, an indicator to notify the profile of the cNF at the registration entity, and an indicator to delete the profile of the cNF at the registration entity.

The registration request may further comprise an identifier of an EAS; a mapping of a Domain Name Service, DNS, name of the cNF to a locator address of the EAS comprising the in-network computing service; an indicator of termination of the EAS by the cNF; an identifier of a subsequent cNF of the cNF in the EAS; an indicator of support for analytics data collection for the cNF; and an indicator of a serving area of the cNF.

In a possible implementation form, for informing on the EAS, the EASDF may further be configured to receive a discovery request from a User Equipment, UE, of the cellular network; resolve the discovery request in cooperation with an inquiry entity of the cellular network; and send a discovery response to the UE. The discovery request may comprise the identifier of the EAS; the DNS name of the EAS; a query indicator regarding a support of the EAS by the in-network computing service; an identifier of a required version of the in-network computing service; and a query indicator regarding a configuration of the cNF to terminate the EAS. The discovery response may comprise the identifier of the EAS; the locator address of the EAS and/or a locator address of a corresponding EAS with no support by the in-network computing service; a response indicator regarding the support of the EAS by the in-network computing service; an identifier of a version of the in-network computing service; and a response indicator regarding the configuration of the cNF to terminate the EAS.

The inquiry entity of the cellular network may comprise one of: a Network Repository Function, NRF, of the cellular network, a Unified Data Management, UDM, entity of the cellular network, and an application service provider, ASP, of the EAS.

According to a fourth aspect, a network function entity, cNF, for a core network of a cellular network is provided. The cNF is configured to register the cNF with a registration entity of the cellular network. The cNF is further configured to carry out a local configuration of the cNF for a PDU session being based on an edge application service, EAS, of the cellular network. The EAS comprises an in-network computing service being based on the network function entity, cNF.

This enables a cNF to form part of an INC service in the core network, wherein the INC service off-loads an existing EAS hosted outside of the cellular network in a DN domain by preprocessing or terminating user plane traffics.

In a possible implementation form, for registering the cNF, the cNF may further be configured to send a registration request with the registration entity of the cellular network. The cNF may further be configured to receive a registration response from the registration entity. The registration request may comprise one of: an indicator to create a profile of the cNF at the registration entity, an indicator to update the profile of the cNF at the registration entity, an indicator to notify the profile of the cNF at the registration entity, and an indicator to delete the profile of the cNF at the registration entity.

In a possible implementation form, the registration request may further comprise: an identifier of the EAS; a mapping of a Domain Name Service, DNS, name of the cNF to a locator address of the cNF; an indicator of termination of the EAS by the cNF; an identifier of a subsequent cNF of the cNF in the EAS; an indicator of support for analytics data collection for the cNF; and an indicator of a serving area of the cNF.

In a possible implementation form, the registration entity may comprise an edge application service discovery function, EASDF, of the cellular network.

In a possible implementation form, the registration entity may comprise a network repository function, NRF, of the cellular network.

In a possible implementation form, for carrying out the local configuration of the cNF for the PDU session, the cNF may further be configured to receive a configuration request from a Session Management Function, SMF, of the cellular network; and send a configuration response to the SMF. The configuration request may comprise one or more of an entry point of a subsequent cNF of the cNF in the EAS; and a termination rule for the EAS. The configuration response may comprise a locator address for a UE to access the EAS comprising the in-network computing service.

In a possible implementation form, the cNF may comprise a user plane function.

According to a fifth aspect, a method is provided of operating a user equipment, UE, for a cellular network. The method comprises: discovering an edge application service, EAS, of the cellular network; and establishing a protocol data unit, PDU, session being based on the discovered EAS. The EAS comprises an in-network computing service being based on a network function entity, cNF, in a core network of the cellular network.

According to a sixth aspect, a method is provided of operating a session management function, SMF, of a cellular network. The method comprises establishing a PDU session being based on an edge application service, EAS, of the cellular network. The EAS comprises an in-network computing service being based on a network function entity, cNF, in a core network of the cellular network.

According to a seventh aspect, a method is provided of operating an edge application service discovery function, EASDF, of a cellular network. The method comprises informing on an edge application service, EAS, of the cellular network. The EAS comprises an in-network computing service being based on a network function entity, cNF, in a core network of the cellular network.

According to an eighth aspect, a method is provided of operating a network function entity, cNF, for a core network of a cellular network. The method comprises registering the cNF with a registration entity of the cellular network; and carrying out a local configuration of the cNF for a PDU session being based on an edge application service, EAS, of the cellular network. The EAS comprises an in-network computing service being based on a network function entity, cNF.

According to a ninth aspect, a computer program is provided. The computer program comprises a program code for performing the method according to any one of the fifth to eighth aspect or any of their implementations, when executed on a computer.

The technical effects and advantages described above in relation with the UE of the first aspect and the control plane network functions of the second to fourth aspects equally apply to the methods of the fifth to eighth aspects having corresponding features, and to the computer program of the ninth aspect realizing said methods.

### BRIEF DESCRIPTION OF DRAWINGS

The above-described aspects and implementations will now be explained with reference to the accompanying drawings, in which the same or similar reference numerals designate the same or similar elements.

The drawings are to be regarded as being schematic representations, and elements illustrated in the drawings are not necessarily shown to scale. Rather, the various elements are represented such that their function and general purpose become apparent to those skilled in the art.

FIG. 1 illustrates an exemplary reference architecture of a 3GPP cellular network;

FIG. 2 illustrates a UE, relevant network functions and corresponding methods of operating the same in accordance with the present disclosure; and

FIG. 3 illustrates the methods of FIG. 2 in more detail.

### DETAILED DESCRIPTIONS OF DRAWINGS

In the following description, references are made to the accompanying drawings, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding apparatus or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

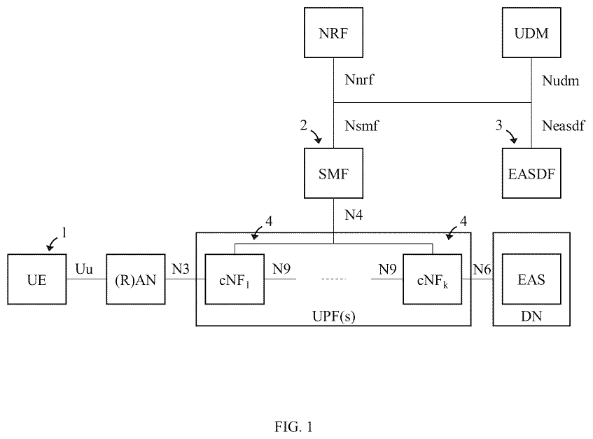

FIG. 1 illustrates an exemplary reference architecture of a 3GPP cellular network.

At the bottom of FIG. 1, the user plane (UP) elements of a forwarding path of a 3GPP network are shown. The forwarding path extends between a user equipment (UE) to the left of FIG. 1 and a data network (DN) domain to the right of FIG. 1 and traverses a 3GPP (radio) access network ((R) AN) domain and a 3GPP core network (CN) domain including one or more (i.e., a chain of) user plane functions (UPF), i.e., network functions (NFs) 4.

A user plane function as used herein may refer to an interconnection point between the cellular network and the DN, providing functions such as (see 3GPP TS 23.501): packet encapsulation and decapsulation, packet routing and forwarding, per-flow QoS handling, providing mobility as a Protocol Data Unit (PDU) session anchor point, etc.

A network function as used herein may refer to one of a plurality of elements of a CN domain of a cellular network designed to provide a particular fraction of the overall functionality of the CN. Network functions may coarsely be distinguished according to their UP/CP affiliation. For example, UPFs represent a particular kind of UP NFs. Most network functions may be realized as a software/computer program for execution on commercial off-the-shelf cloud computing platforms.

The (R) AN domain and the core network domain interface with one another via an N3 reference point.

In the example of FIG. 1, NFs that are standardized for the 3GPP core network are omitted, such that only UPFs with IN-AL are shown, being denoted as computing network functions (cNF) 4 for simplicity. A cNF as used herein may comprise a non-standardized application-specific computing logical (i.e., an IN-AL) that is defined and deployed according to the requirement of an ASP/UE. The network functions 4 of the chain are denoted as cNFk with enumerator k. As such, the one or more cNFs 4 along the forwarding path are implemented as a special type of UPF with the IN-AL. The one or more cNFs 4 interface with one another via N9 reference points.

The cNF(s) 4 are associated with an EAS deployed in a DN domain. The respective cNF 4 can act as a preprocessing part or a termination point of the associated EAS. For the first mode, the cNF 4 is only responsible for some preparation tasks for the EAS. For the second mode, the cNF 4 itself can provide full services to the UE 1 and the UP traffic can terminate at one cNF 4, rather not definitely arriving at the end server side. An ASP can decide using which mode or combining the two modes to design a specific service, taking characteristics of the EAS, resource availability, and expected QoS into consideration. Different UEs 1 may also receive different treatments of the IN-AL according to the UE profile (e.g., the location of the UE 1 and/or processing capability of the UE 1). As a result, for a specific EAS, some UE traffics may be processed at cNF₁ and terminate there, some UE traffics may be processed at cNF₁, cNF₂ and terminate at cNF₂, some UE traffic may be processed at cNF₁, cNF₂ and continues to the DN, and some UE traffic maybe processed and terminated at cNF₃ instead, etc.

The CN domain and the DN domain interface with one another via an N6 reference point.

At the top of FIG. 1, the relevant CP elements of the 3GPP network are shown. The session management function (SMF) 2, and the edge application service discovery function (EASDF) 3 are of particular relevance for the present disclosure.

The SMF 2 is a CP element for interactions with the UP. This includes creating, updating and removing Protocol Data Unit (PDU) sessions and managing session context with the one or more UPFs 4 of the CN domain via an N4 reference point.

The EASDF 3 is a CP element for facilitating a discovery of edge application servers/services (EAS) for UEs. The EASDF 3 acts as a Domain Name System (DNS) resolver to the UE 1 and can complement DNS queries with location-based information in accordance with a UE location. This enables a resolution to EAS close to the UE location. The EASDF 3 interfaces with other CP elements via an N_{easdf} reference point.

Other CP elements comprise the network repository function (NRF) and the unified data manager (UDM) functions.

The NRF is a CP element which essentially acts as an index that can be consulted by other NFs, so they can discover information regarding other entities present in the CN domain. The NRF interfaces with other CP elements via an N_{nrf} reference point.

The UDM is a CP element for managing data for access authorization, user registration, and DN profiles. The UDM interfaces with other CP elements via an N_{udm} reference point.

The service provisioning will be done by the EASDF 3, coordinating with the SMF 2 and the UE 1. The service provisioning may also involve the end server side located in the DN.

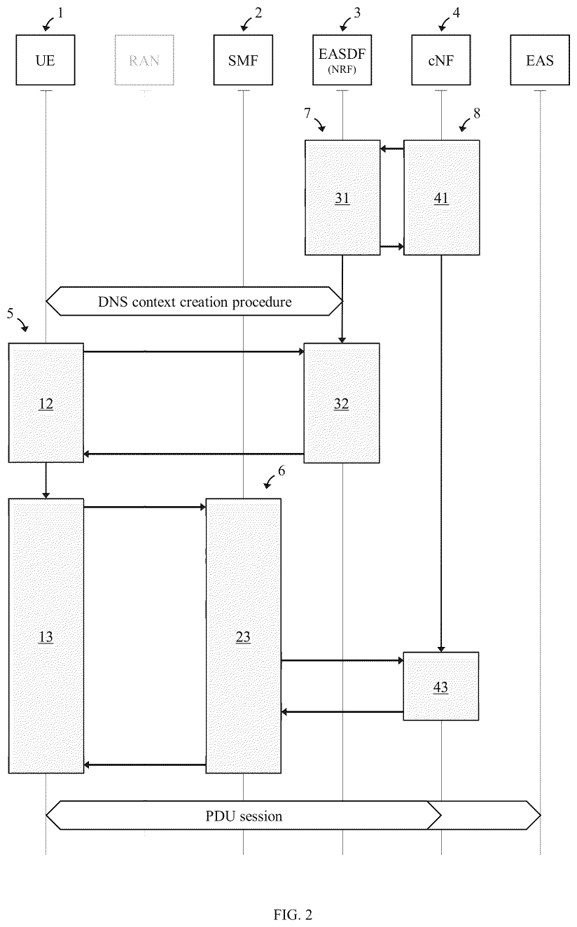

FIG. 2 illustrates a UE 1, relevant network functions 2-4 and corresponding methods 5-8 of operating the same in accordance with the present disclosure.

At the top of FIG. 1, the relevant CP elements of the 3GPP network are shown. From left to right, a UE 1, a RAN, an SMF 2, an EASDF 3, an exemplary cNF 4, and an EAS are shown.

These CP elements represent network entities in the CP of a cellular network system.

The UE 1, SMF 2, EASDF 3 and cNF 4 may respectively be operated in accordance with corresponding methods 5-8, each of which has a part to play in provisioning a PDU session that is based on an EAS comprising an INC service based on a cNF 4.

The CP elements 1-4 may be implemented in hardware/software such as computer programs implementing the methods 5-8 to the CP elements.

In a high-level view, the provisioning may be achieved in accordance with a signaling being carried out from top to bottom of FIG. 2:

First, a registration procedure is needed to expose the existence and capability of the instantiated cNF 4 to the EASDF 3.

To start with, the cNF 4 is configured to register 41 itself with a registration entity of the cellular network, such as an EASDF 3 in the example of FIG. 2 (direct registration), or alternatively an NRF (indirect registration, not shown).

Correspondingly, the EASDF 3 is configured to register 31 the cNF 4.

Second, a service discovery request and response procedure is needed between the UE 1 and the EASDF 3, so that the information of previously registered cNF(s) 4 can be provided according to a request from the UE 1 indicating a use of a particular type of cNF 4 for an EAS.

Accordingly, the UE 1 is configured to discover 12 the EAS comprising the INC service based on the cNF 4, by approaching the EASDF 4.

Correspondingly, the EASDF 4 is further configured to inform 32 the UE 1 on the EAS comprising the INC service based on the cNF 4.

Third, a session establishment/modification procedure is needed between the UE 1 and the SMF 2, so that the SMF 2 can discover and identify appropriate cNF(s) 4 and accordingly a PDU session can be properly established. This PDU session may or may not terminate at the chosen cNF 4, which depends on the particular application scenario triggered by the UE 1.

Thus, the UE 1 is further configured to establish 13 a PDU session based on the discovered EAS, by approaching the SMF 2.

Correspondingly, the SMF 2 is configured to establish 23 the PDU session based on the EAS comprising the INC service based on the cNF 4, by approaching the cNF 4.

Correspondingly, the cNF 4 is further configured to carry out 43 a local configuration of the cNF 4 for the PDU session based on the EAS comprising the INC service based on the cNF 4.

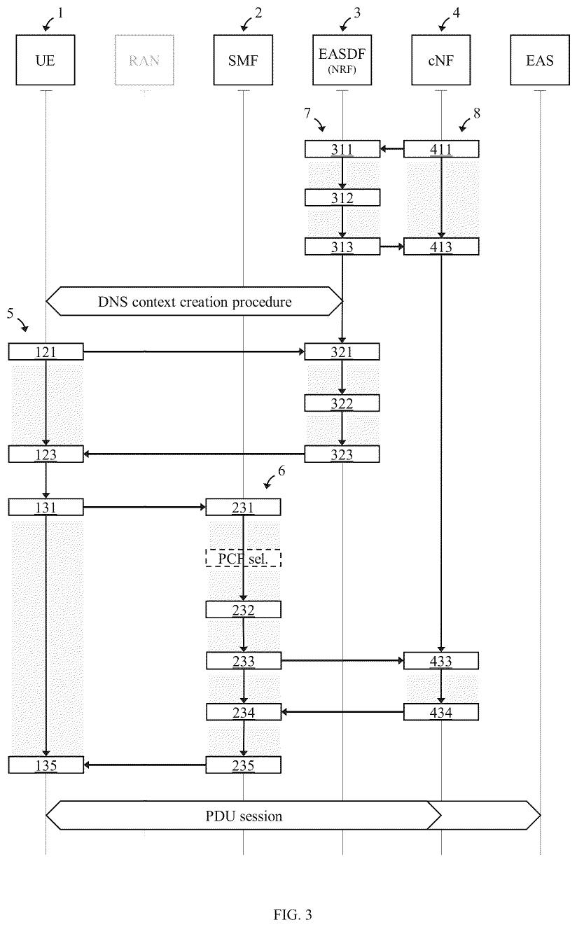

FIG. 3 illustrates the methods 5-8 of FIG. 2 in more detail.

The signaling begins at the cNF 4, which is configured to register 41 the cNF 4 (i.e., itself) with a registration entity of the cellular network.

The registration entity may comprise an EASDF 3 (as shown in FIG. 3) of the cellular network or an NRF (see FIG. 1), of the cellular network.

For registering 41 the cNF 4, the cNF 4 may be configured to send 411 a registration request with the registration entity of the cellular network.

The registration request may comprise one of: an indicator to create a profile of the cNF 4 at the registration entity, an indicator to update the profile of the cNF 4 at the registration entity, an indicator to notify the profile of the cNF 4 at the registration entity, and an indicator to delete the profile of the cNF 4 at the registration entity.

Different to a normal UPF/NF, the cNF 4 is not independent as it associates to an existing EAS locating in a DN.

The registration request may further comprise an identifier (“EdgeAppId”) of the EAS; a mapping of a DNS name of the cNF 4 to a locator address of the EAS comprising the INC service (“DnsToIp”); an indicator of termination of the EAS by the cNF 4 (“IsTerminated”); an identifier of a subsequent cNF 4 of the cNF 4 in the EAS (“FuncChainId”); an indicator of support for analytics data collection for the cNF 4 (“IsDataCollectionSupported”); and an indicator of a serving area of the cNF 4 (“ServingArea”).

First, the “EdgeAppID” parameter represents the ID value of the associated EAS, since a cNF aims to enhance the experience and performance of an existing EAS. This information can help the network operator to further optimize the quality-of-service and user experience for this EAS.

Second, the “IsTerminated” parameter tells whether this cNF 4 can serve as a termination point for the EAS indicated by “EdgeAppId”. This decides if UP traffic will be terminated in 3GPP network domain, or the UP traffic will further transfer to the external such as DN. This parameter also helps the network operator to make more precise decision for an EAS. In case this attribute is not defined, it can be a termination point for some of the traffic only.

Third, the “FuncChainId” parameter specifies the service function chain identifier if the cNF 4 cannot be a termination point. If the cNF 4 is not a termination point, then the cNF 4 will forward the processed UP traffics to a next stop, which could be one another cNF 4 or a set of cNFs 4 that form a service function chain (SFC). This parameter tells that the network operator can further identify the SFC by the “FuncChainId”. As such, if “IsTerminated” is FALSE, the “FuncChainId” parameter may represent the ID value of the chained service function for the next processing step.

Fourth, the “IsDataCollectionSupported” parameter specifies whether or not this cNF 4 supports data collection by the network, in particular by a NWDAF. If so, the NWDAF can collect running data on the cNF 4 for analysis in order to serve other purposes like learning for network control, optimization and so on; otherwise, the network operator cannot collect the running data.

Fifth, the “ServingArea” parameter may, for example, represent Tracking Area Identifiers (TAI(s)) being indicative of the UE locations being served by this cNF 4.

The registration request may further comprise all existing profile parameters mentioned in clause 5.2.7.2.2 of 3GPP TS 23.502.

The profile parameters provide a clear description of an INC service that is available from the CN, which helps the CP later on to identify appropriate cNF instances.

The signaling proceeds to the EASDF 3, which is correspondingly configured to register 31 the cNF 4.

For registering 31 the cNF 4, the EASDF 3 may be configured to receive 311 the registration request from the cNF 4.

The EASDF 3 may further be configured to process 312 the profile of the cNF 4 in accordance with the registration request. For example, the EASDF 3 may verify the profile data of the cNF 4, and may further store the profile data of the cNF 4.

The EASDF 3 may further be configured to send 313 a registration response to the cNF 4.

A similar registration procedure may be carried out in connection with an NRF (see FIG. 1) of the cellular network as the registration entity. If the cNF 4 is a non-trusted entity that is deployed by a third party, it has to register through a NEF of the cellular network.

The signaling returns to the cNF4. For registering 41 the cNF 4, the cNF 4 may correspondingly be configured to receive 413 the registration response from the registration entity.

The signaling proceeds at the UE 1, which is configured to discover 12 the EAS comprising the INC service based on the cNF 4.

The UE 1 discovers the EASDF 3 via the SMF 2. This follows the similar procedure defined in Step 1 to 6 of clause 6.2.3.2.2 of 3GPP TS 23.548 (“EAS Discovery Procedure with EASDF”).

It is assumed that the EASDF 3 is registered at the NRF of the cellular network and that the SMF 2 knows which EASDF 3 it should get in touch with. The information of an EASDF 3 can be configured to the UE 1 or it can be dynamically retrieved during the PDU session establishment. Here also includes the necessary procedures and interactions between AMF and SMF 2 including creating UE context and exchanging information between RAN and AMF in order to establish this PDU session.

For discovering 12 the EAS, the UE 1 may then be configured to send 121 a discovery request to the EASDF 3 via an established PDU session.

The discovery request may comprise: the identifier (“EdgeAppId”) of the EAS, a DNS name of the EAS (“DNSAddress”), a query indicator regarding a support of the EAS by the INC service (“IsINCSupported”), an identifier of a required version of the INC service (“INCALVersion”), and a query indicator regarding a configuration of the cNF 4 to terminate the EAS (“HasTerminationPoint”).

First, the “EdgeAppId” parameter may represent the ID value of the EAS with which the cNF 4 is associated.

Second, the “IsINCSupported” parameter may indicate to check whether the associated EAS has an INC enhancement option.

Third, the “INCALVersion” parameter may specify the requested ID of the version of the INC/IN-AL for the associated EAS.

Fourth, the “HasTerminationPoint” parameter may indicate to check whether the INC service (if existing) can serve as a termination point for the associated EAS.

The discovery request allows a UE to indicate an INC application service request that associates with a certain EAS. This request will also trigger the EASDF 3 to discover the corresponding cNF instances that are available in the CN.

The signaling proceeds to the EASDF 3, which is correspondingly configured to inform 32 the UE 1 on the EAS comprising the INC service based on the cNF 4.

For informing 32 on the EAS, the EASDF 3 may further be configured to receive 321 the discovery request from the UE 1, resolve 322 the discovery request in cooperation with an inquiry entity of the cellular network, and send 323 a discovery response to the UE 1.

The inquiry entity of the cellular network may comprise one of: a NRF of the cellular network, a UDM entity of the cellular network, and an application service provider (ASP) of the EAS.

Resolving 322 the discovery request may particularly include checking the profile data of the requesting UE 1, and/or resolving the DNS name of the requested EAS according to its received application identifier with a locator address (i.e., an IP address).

The discovery response may comprise the identifier of the EAS (“EdgeAppId”); the locator address of the EAS and/or a locator address of a corresponding EAS with no support by the INC service (“DNSResolvedInfo”); a response indicator regarding the support of the EAS by the INC service (“IsINCSupported”); an identifier of a version of the INC service (“INCALVersion”); and a response indicator regarding the configuration of the cNF 4 to terminate the EAS (“HasTerminationPoint”).

The signaling returns to the UE 1. For discovering 12 the EAS, the UE 1 may correspondingly be configured to receive 123 the discovery response from the EASDF 3.

The UE 1 is further configured to establish 13 the PDU session based on the discovered EAS.

For establishing 13 the PDU session, the UE 1 may be configured to send 131 a PDU session request to the SMF 2 of the cellular network, via the RAN and the AMF of the cellular network.

The PDU session request may comprise the locator address of the EAS comprising the INC service (“DNSResolvedInfo”). That is to say, the PDU session based on the EAS comprising an INC service based on the cNF 4 is requested by specifying this locator address (EAS entry point) in the PDU session request. If the terminated flag is set in the PDU session request, UP traffic may be terminated at the cNF 4 as the final destination, and if the terminated flag is not set in the PDU session request, UP traffic can be forwarded to other cNF(s) 4 such as a service function chain, normal UPF(s) and/or directly to the EAS in the DN domain.

The signaling proceeds to the SMF 2, which is correspondingly configured to establish 23 the PDU session based on the EAS comprising the INC service based on the cNF 4.

For establishing 23 the PDU session, the SMF 2 may be configured to receive 231 the PDU session request from the UE 1.

Optionally, the SMF 2 may need to request a PCF of the cellular network in order to check the policy of the requested EAS including the INC service indicated in the PDU session request. This allows the SMF 2 to decide whether or not such a requested service is permitted according to the profile of the UE 1.

Optionally, the SMF 2 may need to request the NRF of the cellular network about the information of the deployed cNF(s) 4 in the CN domain so that it can select the one or multiple that satisfy the requirement of the EAS/INC service indicated in the PDU session request from the UE 1. The information may include the locations and capabilities of the instantiated cNF(s) 4, profile data of the cNF(s) 4 related to the EAS in terms of the application identifier contained in the PDU session request from the UE 1.

As such, for establishing 23 the PDU session, the SMF 2 may further be configured to select 232 the cNF 4 among a number of registered cNFs 4 of the cellular network.

For establishing 23 the PDU session, the SMF 2 may further be configured to send 233 a configuration request to the selected cNF 4. In other words, the SMF 2 may configure the selected cNF(s) 4 for the requested INC-enabled EAS.

The configuration request may comprise one or more of: an entry point of the INC-enabled EAS, an entry point of a subsequent cNF 4 of the selected cNF 4 in the EAS; and a termination rule for the EAS.

The signaling proceeds to the one or more selected cNF(s) 4, which is/are correspondingly configured to carry out 43 a local configuration of the respective cNF 4 for the PDU session based on the EAS comprising the INC service based on the cNF 4.

For carrying out 43 the local configuration of the cNF(s) 4 for the PDU session, the respective selected cNF 4 may further be configured to receive 433 the configuration request from the SMF 2, and send 434 a configuration response to the SMF 2.

The configuration response may comprise a locator address for the UE 1 (i.e., that the UE 1 may use) to access the EAS comprising the INC service based on the cNF 4.

The signaling returns to the SMF 2. For establishing 23 the PDU session, the SMF 2 may correspondingly be configured to receive 234 the configuration response from the selected cNF 4.

For establishing 23 the PDU session, the SMF 2 may further be configured to send 235 a PDU session request acceptance to the UE 1, via the AMF and the RAN of the cellular network.

The PDU session request acceptance may comprise the locator address for the UE 1 to access the EAS comprising the INC service based on the cNF 4.

The signaling returns to the UE 1. For establishing 13 the PDU session, the UE 1 may correspondingly be configured to receive 135 the PDU session request acceptance from the SMF 2.

This concludes the provisioning of the PDU session that is based on the INC-enabled EAS based on the cNF 4.

The UE 1 can subsequently access the INC service of the EAS with the provided information. The procedure is similar to the procedure defined in clause 4.3.2.2 of 3GPP TS 23.502, which includes both uplink and downlink data traffic enabling procedures between the cNF 4, the AMF and the SMF 2.

The present disclosure has been described in conjunction with various embodiments as examples as well as implementations. However, other variations can be understood and effected by those persons skilled in the art and practicing the claimed matter, from the studies of the drawings, this disclosure and the independent claims.

For example, if other types of network systems are considered (e.g., WLAN, LAN), the operator of a network can utilize this disclosure to deploy an INC service in its network domain as well. In that case, the network elements (e.g., switches/routers) shall be programmable and the MP should be able to manage network elements in order to deploy the components of the INC part on the network elements for an AS. Specifically, a cNF 4 with a specific IN-AL can be instantiated on one or multiple network elements.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation. A computer program may be stored/distributed on a suitable medium, such as an optical storage medium or a solid-state medium supplied together with or as part of other hardware, but may also be distributed in other forms, such as via the Internet or other wired or wireless telecommunication systems.

What is claimed is:

1. A user equipment, UE (1), for a cellular network, wherein the UE (1) is configured to
discover (12) an edge application service, EAS, of the cellular network, wherein the EAS comprises an in-network computing service being based on a network function entity, cNF (4), in a core network of the cellular network; and
establish (13) a protocol data unit, PDU, session being based on the discovered EAS.

2. The UE (1) of claim 1, wherein for discovering (12) the EAS, the UE (1) is further configured to
send (121) a discovery request to an edge application service discovery function, EASDF (3), of the cellular network, the discovery request comprising
an identifier of the EAS;
a Domain Name Service, DNS, name of the EAS;
a query indicator regarding a support of the EAS by the in-network computing service;
an identifier of a required version of the in-network computing service; and
a query indicator regarding a configuration of the cNF (4) to terminate the EAS.

3. The UE (1) of claim 1, wherein for discovering (12) the EAS, the UE (1) is further configured to
receive (123) a discovery response from the EASDF (3), the discovery response comprising
the identifier of the EAS;
the locator address of the EAS comprising the in-network computing service and/or a locator address of a corresponding EAS not comprising the in-network computing service;
a response indicator regarding the support of the EAS by the in-network computing service;
an identifier of a version of the in-network computing service; and
a response indicator regarding the configuration of the cNF (4) to terminate the EAS.

4. The UE (1) of claim 1, wherein for establishing (13) the PDU session, the UE (1) is configured to
send (131) a PDU session request to a Session Management Function, SMF (2), of the cellular network, the PDU session request comprising
the locator address of the EAS comprising the in-network computing service.

5. The UE (1) of claim 4, wherein for establishing (13) the PDU session, the UE (1) is further configured to
receive (135) a PDU session request acceptance from the SMF (2), the PDU session request acceptance comprising
a locator address for the UE (1) to access the EAS comprising the in-network computing service.

6. An edge application service discovery function, EASDF (3), for a cellular network, wherein the EASDF (3) is configured to
register (31) a network function entity, cNF (4), for a core network of the cellular network; and
inform (32) on an edge application service, EAS, of the cellular network, the EAS comprising an in-network computing service being based on the network function entity, cNF (4).

7. The EASDF (3) of claim 6, wherein for registering (31) the cNF (4), the EASDF (3) is further configured to
receive (311) a registration request from the cNF (4), the registration request comprising one of
an indicator to create a profile of the cNF (4) at the registration entity,
an indicator to update the profile of the cNF (4) at the registration entity,
an indicator to notify the profile of the cNF (4) at the registration entity, and
an indicator to delete the profile of the cNF (4) at the registration entity; and
process (312) the profile of the cNF (4) in accordance with the registration request; and
send (313) a registration response to the cNF (4).

8. The EASDF (3) of claim 7,
the registration request further comprising
an identifier of an EAS;
a mapping of a Domain Name Service, DNS, name of the cNF (4) to a locator address of the EAS comprising the in-network computing service);
an indicator of termination of the EAS by the cNF (4);
an identifier of a subsequent cNF (4) of the cNF (4) in the EAS;
an indicator of support for analytics data collection for the cNF (4); and
an indicator of a serving area of the cNF (4).

9. The EASDF (3) of claim 6, wherein for informing (32) on the EAS, the EASDF (3) is further configured to
receive (321) a discovery request from a User Equipment, UE (1), of the cellular network, the discovery request comprising
the identifier of the EAS;
the DNS name of the EAS;
a query indicator regarding a support of the EAS by the in-network computing service;
an identifier of a required version of the in-network computing service; and
a query indicator regarding a configuration of the cNF (4) to terminate the EAS;
resolve (322) the discovery request in cooperation with an inquiry entity of the cellular network; and
send (323) a discovery response to the UE (1), the discovery response comprising
the identifier of the EAS;
the locator address of the EAS and/or a locator address of a corresponding EAS with no support by the in-network computing service;
a response indicator regarding the support of the EAS by the in-network computing service;
an identifier of a version of the in-network computing service; and
a response indicator regarding the configuration of the cNF (4) to terminate the EAS.

10. The EASDF (3) of claim 9,
the inquiry entity of the cellular network comprising one of:
a Network Repository Function, NRF, of the cellular network,
a Unified Data Management, UDM, entity of the cellular network, and
an application service provider, ASP, of the EAS.

11. A network function entity, cNF (4), for a core network of a cellular network, wherein the cNF (4) is configured to
register (41) the cNF (4) with a registration entity of the cellular network; and
carry out (43) a local configuration of the cNF (4) for a PDU session being based on an edge application service, EAS, of the cellular network, the EAS comprising an in-network computing service being based on the network function entity, cNF (4).

12. The cNF (4) of claim 11, wherein for registering (41) the cNF (4), the cNF (4) is further configured to
send (411) a registration request with the registration entity of the cellular network, the registration request comprising one of
an indicator to create a profile of the cNF (4) at the registration entity,
an indicator to update the profile of the cNF (4) at the registration entity,
an indicator to notify the profile of the cNF (4) at the registration entity, and
an indicator to delete the profile of the cNF (4) at the registration entity; and
receive (413) a registration response from the registration entity.

13. The cNF (4) of claim 12,
the registration request further comprising
an identifier of the EAS;
a mapping of a Domain Name Service, DNS, name of the cNF (4) to a locator address of the cNF (4);
an indicator of termination of the EAS by the cNF (4);
an identifier of a subsequent cNF (4) of the cNF (4) in the EAS;
an indicator of support for analytics data collection for the cNF (4); and
an indicator of a serving area of the cNF (4).

14. The cNF (4) of claim 11, the registration entity comprising an edge application service discovery function, EASDF (3), of the cellular network.

15. The cNF (4) of claim 11, the registration entity comprising
a Network Repository Function, NRF, of the cellular network.

16. The cNF (4) of claim 11, wherein for carrying out (43) the local configuration of the cNF (4) for the PDU session, the cNF (4) is further configured to
receive (433) a configuration request from a Session Management Function, SMF (2), of the cellular network, the configuration request comprising one or more of
an entry point of a subsequent cNF (4) of the cNF (4) in the EAS; and
a termination rule for the EAS; and
send (434) a configuration response to the SMF (2), the configuration response comprising
a locator address for a UE (1) to access the EAS comprising the in-network computing service.
